(19) United States
(12) Patent Application Publication
(10) Pub. No.: US 2011/0031832 A1
(43) Pub. Date: Feb. 10, 2011

(54) FAN SEAT STRUCTURE

(75) Inventors: Zizhou Jia, Sinjhuang City (TW); Shun-Hui Huang, Sinjhuang City, Taipei (TW); Qi Ai, Sinjhuang City (TW)

Correspondence Address: C. G. Mersereau;NIKOLAI & MERSEREAU, P.A., Suite 820, 900 Second Avenue South, Minneapolis, MN, 55402, US

(73) Assignee: ASIA VITAL COMPONENTS CO., LTD., Sinjhuang City (TW)

(21) Appl. No.: 12/536,497

(22) Filed: Aug. 6, 2009

(51) Int. Cl. H02K 5/167

(52) U.S. Cl. 310/90

(57) ABSTRACT

A fan seat structure includes a seat and a snap-fitting member. The seat is formed on a top with a supporting face, from where a bearing cup is upward extended; and a portion of the seat corresponding to the bearing cup is formed into a central passage. The snap-fitting member is assembled to the seat at the central passage, and is integrally formed with a hollow tubular section upward extended toward the bearing cup; and a limiting section and a pressure-proof section are integrally provided in the hollow tubular section. With the snap-fitting member, a cooling fan can have simplified structure and be more stably and reliably assembled, ensuring the cooling fan to have enhanced performance and be manufactured at reduced time, labor and cost.

### FIELD OF THE INVENTION

The present invention relates to a fan seat structure, and more particularly to a fan seat structure that enables a cooling fan to have simplified structure and be assembled with less procedures, time and labor while having enhanced performance.

### BACKGROUND OF THE INVENTION

With the constantly increased integration of circuits in the integrated circuit (IC) chips, heat produced by the IC chips during the operation thereof also increases constantly. Therefore, when a personal computer operates, IC chips with high integration, such as the central processing unit (CPU) and the graphics chip would produce a large amount of heat. For the above-mentioned IC chips to maintain long-term normal operation, it is a must for the IC chips to maintain at an optimal working temperature to avoid deteriorated function or damage caused by overheat. A heat dissipation unit is usually mounted to directly contact with a surface of an electronic element, so as to remove the heat produced by the electronic element and ensure normal operation and prolonged service life of the electronic element.

Among others, the cooling fan has become one of many requisite parts for various kinds of heat dissipation units. This is because the cooling fan can quickly dissipate the heat absorbed by a radiating fin assembly into ambient air to provide good air circulation and heat dissipation efficiency.

FIG. 1 is an assembled sectional view showing a conventional cooling fan. As shown, the conventional cooling fan includes a rotor 1 and a seat 2. The rotor 1 is located above the seat 2, and is provided at a center with a rotor shaft 11 extended toward the seat 2. The seat 2 is provided at a center with a central extension section 21, which internally defines a receiving space 211. A pressure-proof strip 23 is disposed on an inner bottom of the receiving space 211. An outer periphery of the central extension section 21 further extends upward to form a bearing cup 22 for receiving a bearing 24 and a retaining ring 25 therein. The retaining ring 25 and the bearing 24 are sequentially stacked on the central extension section 21. The rotor 1 is located above the seat 2 with the rotor shaft 11 sequentially downward extending through the bearing 24 and the retaining ring 25 to press against the pressure-proof strip 23.

To assemble the conventional cooling fan, the pressure-proof strip 23 is disposed on the inner bottom of the receiving space 211 in the central extension section 21, so that when the rotor 1 rotates above the seat 2, the rotor shaft 11 rotates while contacting with the pressure-proof strip 23. The pressure-proof strip 23 disposed in the receiving space 211 might become loosened or unstable when the receiving space 211 has an exceeded length and the rotor shaft 11 fails to effectively press against the pressure-proof strip 23. Under this circumstance, the rotor 1 and the blades on the rotor 1 could not rotate in a normal condition. Moreover, after the pressure-proof strip 23 has been disposed in the receiving space 211, the retaining ring 25 must then be disposed on the top of the central extension section 21 and the rotor shaft 11 must be extended through the retaining ring 25 into the receiving space 211 to press against the pressure-proof strip 23. Therefore, complicated procedures and a lot of labor and time are involved in assembling the cooling fan to increase the labor cost thereof. Moreover, it is difficult to precisely control the process of assembling the parts, and the rotor shaft 11 can not be effectively axially positioned. Therefore, the problem of unstable rotating speed of the rotor shaft 11 during the operation of the cooling fan will occur.

In brief, the conventional cooling fan has the following disadvantages: (1) the rotor shaft tends to become loosened and unstable; (2) a lot of manufacturing procedures and labor and time are required; (3) increased labor cost is required; (4) it is difficult to precisely control the assembling of different parts; and (5) the fan tends to rotate at unstable rotating speed.

It is therefore tried by the inventor to develop an improved fan seat structure to overcome the problems in assembling the conventional cooling fan.

### SUMMARY OF THE INVENTION

A primary object of the present invention is to provide a fan seat structure that has integrally formed limiting section, pressure-proof section and snap-fitting member to enable a cooling fan to have simplified structure and be more stably and reliably assembled.

Another object of the present invention is to provide a fan seat structure that enables a cooling fan to be assembled with less procedures, time and labor to thereby reduce the manufacturing cost of the cooling fan.

A further object of the present invention is to provide a fan seat structure that enables a cooling fan to have enhanced performance.

A still further object of the present invention is to provide a fan seat structure that prevents the oil contained in a bearing of a cooling fan from leaking and becoming decreased in volume.

To achieve the above and other objects, the fan seat structure according to a preferred embodiment of the present invention includes a seat and a snap-fitting member. The seat is formed on a top with a supporting face, from where a bearing cup is upward extended; and a portion of the seat corresponding to the bearing cup is formed into a central passage. The snap-fitting member is assembled to the seat at the central passage, and is formed at an outer peripheral edge thereof with at least one retaining section for abutting on the supporting face of the seat. The snap-fitting member is integrally formed with a hollow tubular section upward extended toward the bearing cup; and a limiting section and a pressure-proof section are integrally provided to an upper and a lower end of the hollow tubular section, respectively. The limiting section consists of at least one radially inward limiting plate. Since the snap-fitting member is directly snap-fitted to the seat of the fan seat structure, and has integrally formed limiting section and pressure-proof section, a cooling fan with this seat structure can have simplified structure and be more stably and reliably assembled, ensuring the cooling fan to have enhanced performance and be manufactured at reduced time, labor and cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled sectional view showing the seat structure of a conventional cooling fan;

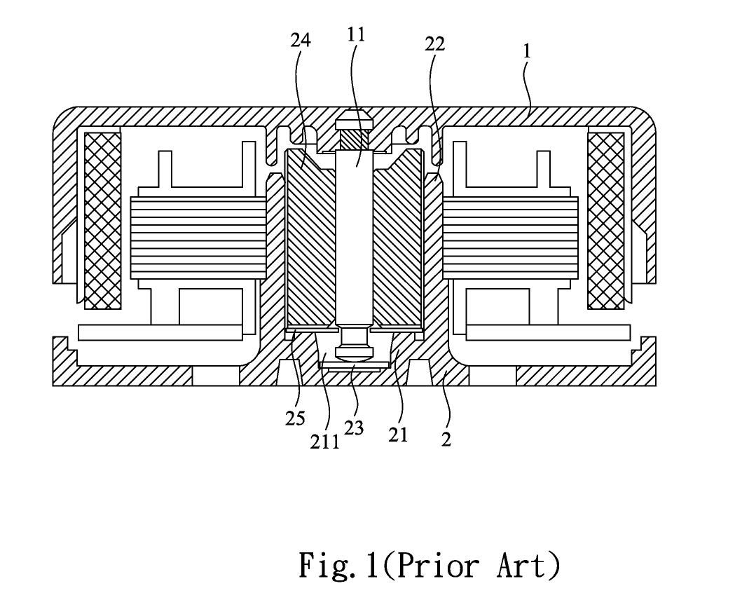

FIG. 2 is an assembled sectional view showing a fan seat structure according to a preferred embodiment of the present invention;

FIG. 3 is an exploded view of FIG. 2; and

FIG. 4 is a top perspective view of a snap-fitting member included the fan seat structure according to the preferred embodiment of the present invention.

### DETAILED DESCRIPTION OF THE PREFERRED EMBODIMENTS

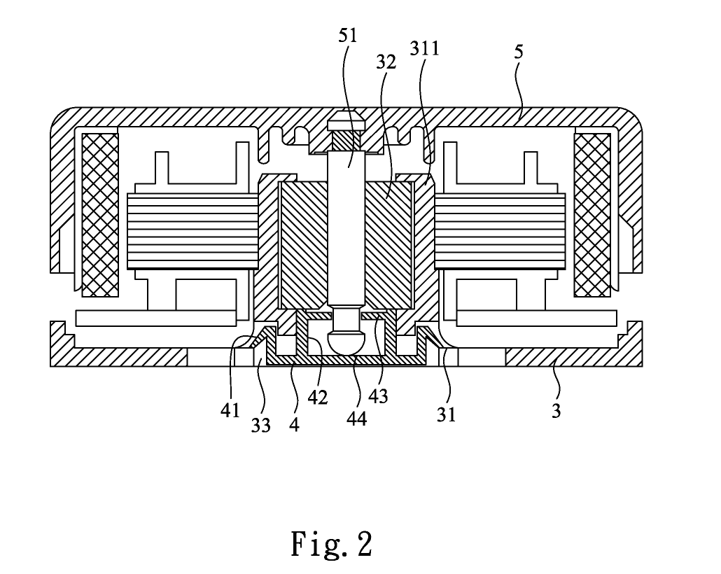

Please refer to FIGS. 2, 3 and 4 at the same time. As shown, a fan seat structure according to a preferred embodiment of the present invention includes a seat 3 and a snap-fitting member 4. The seat 3 is formed on a top with a supporting face 31, from where a bearing cup 311 is upward extended for holding a bearing 32 therein. A portion of the seat 3 corresponding to the bearing cup 3 11 is formed into a central passage 33. The snap-fitting member 4 is assembled to the seat 3 at the central passage 33, and is formed at an outer peripheral edge thereof with at least one retaining section 41 for abutting on the supporting face 31. The snap-fitting member 4 is further integrally formed on one side facing the bearing cup 311 with an upward extended hollow tubular section 42. A radially inward limiting section 43 is provided on an upper end of the hollow tubular section 42, and a pressure-proof section 44 is provided on a lower end of the hollow tubular section 42. Both the limiting section 43 and the pressure-proof section 44 are integrally formed with and extended from the hollow tubular section 42. Further, the limiting section 43 consists of at least one limiting plate 431. And, a rotor shaft 51 extended from a rotor 5 is extended through and received in the bearing 32.

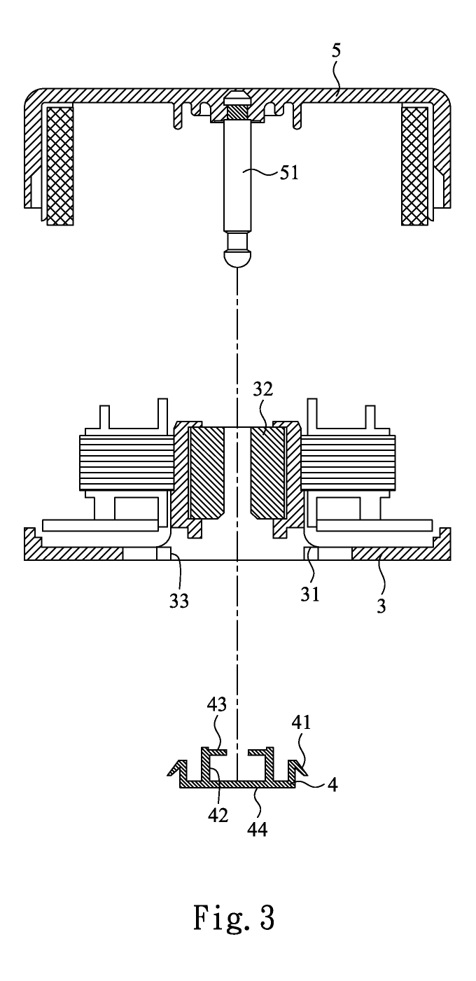

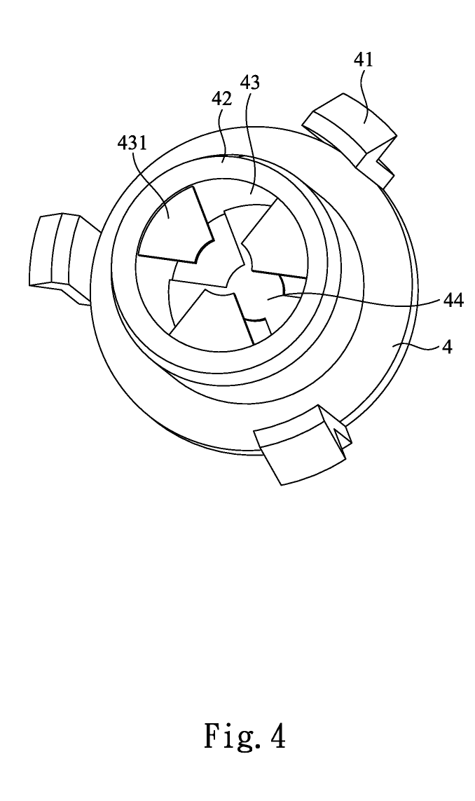

As can be seen in FIGS. 3 and 4, the rotor 5 is assembled to the seat 3, and the rotor shaft 51 is downward extended from a center of the rotor 5. The upward extended bearing cup 311 is located above a center of the seat 3 to receive the bearing 32 therein, and the rotor shaft 51 is downward extended through the bearing 32 to project from a bottom of the bearing 32. The snap-fitting member 4 is upward assembled to the central passage 33 of the seat 3 from a lower side of the seat 3. When the snap-fitting member 4 passes the central passage 33, the at least one retaining section 41 of the snap-fitting member 4 is radially inward compressed by an inner wall surface of the central passage 33. After passing through the central passage 33, the retaining section 41 is released from the compression to expand radially outward and abut on the supporting face 31 of the seat 3, so as to retain the snap-fitting member 4 to the seat 3 at the central passage 33. And, when the snap-fitting member 4 is retained to the central passage 33, the upper end of the hollow tubular section 42 integrally upward extended from the snap-fitting member 4 toward the bearing cup 311 is abutted on the bottom of the bearing 32.

The limiting section 43 is located at the upper end of the hollow tubular section 42 and the pressure-proof section 44 is located at the lower end of the hollow tubular section 42. When the snap-fitting member 4 is assembled and retained to the central passage 33 and the rotor shaft 51 is downward extended through the bearing 32, the rotor shaft 51 is also extended into the hollow tubular section 42. More specifically, the rotor shaft 51 is forced through the at least one limiting plate 431 forming the limiting section 43, and is therefore held in place in the hollow tubular section 42 by the at least one limiting plate 431 with a free end of the rotor shaft 51 pressed against the pressure-proof section 44 at the lower end of the hollow tubular section 42.

Since the limiting section 43 and the pressure-proof section 44 are integrally formed with the snap-fitting member 4, the fan seat structure of the present invention enables the cooling fan to have simplified structure and be more stably and reliably assembled, ensuring the cooling fan to have enhanced performance and be manufactured at reduced time, labor and cost. Moreover, since the rotor shaft 51 is engaged with the integrally formed limiting section 43, pressure-proof section 44 and snap-fitting member 4, oil contained in the bearing 32 is prevented from leaking via the snap-fitting member 4 and can be well retained in the bearing 32.

The present invention has been described with a preferred embodiment thereof and it is understood that many changes and modifications in the described embodiment can be carried out without departing from the scope and the spirit of the invention that is intended to be limited only by the appended claims.

1. A fan seat structure, comprising:
a seat being formed on a top with a supporting face, from which a bearing cup extends upward; and a portion of the bearing cup being formed into a central passage;
a snap-fitting member being assembled to the seat at the central passage, and being integrally formed with an upward extended hollow tubular section; and a limiting section and a pressure-proof section being integrally provided in the hollow tubular section of said snap-fitting member; and
wherein the limiting section consists of at least one limiting plate.

2. The fan seat structure as claimed in claim 1, wherein the snap-fitting member is formed outside the hollow tubular section with at least one retaining section for abutting on the supporting face of the seat.

3. The fan seat structure as claimed in claim 1, wherein the limiting section is radially inward extended from an upper end of the hollow tubular section.

4. The fan seat structure as claimed in claim 1, wherein the pressure- proof section is extended across a lower end of the hollow tubular section.

5. The fan seat structure as claimed in claim 1, wherein the bearing cup receives a bearing therein, and the hollow tubular section has an upper end abutted on a bottom of the bearing.

6. The fan seat structure as claimed in claim 5, wherein the bearing receives a rotor shaft therein, the rotor shaft being downward extended through the limiting section into the hollow tubular section with a free end of the rotor shaft pressed against on the pressure-proof section.

7. (canceled)
